(19) United States
(12) Patent Application Publication
(10) Pub. No.: US 2005/0078440 A1
(43) Pub. Date: Apr. 14, 2005

(54) Compound power supply switch for notebook computers

(76) Inventor: Neng Liu, Hsinchu (TW)

Correspondence Address: HARNESS, DICKEY & PIERCE, P.L.C., P.O. BOX 8910, RESTON, VA, 20195, US

(21) Appl. No.: 10/680,197

(22) Filed: Oct. 8, 2003

(51) Int. Cl. G06F 1/16

(52) U.S. Cl. 361/683

(57) ABSTRACT

A compound power supply switch for notebook computers includes a coupling module and a power supply control module to enable users to unfasten the coupling module between the display panel and the processor, and at the same time activate the power supply control module and enable the processor to enter machine start process, thereby simplifying opening and machine start operations of notebook computers, and also shortening machine start operation time. In addition, extra space may be saved to accommodate other functional devices and meet market demands of multiple functions, slim size, and light weight for notebook computers.

### FIELD OF THE INVENTION

The invention relates to a power supply switch for electric appliances and particularly to a compound power supply switch for notebook computers.

### BACKGROUND OF THE INVENTION

Information appliances are hot products in the digital economy. Their technology is advancing very rapidly. Due to the consumer's growing demands for portable information appliances and to meet the requirements of continually reducing individual living space, slim and light has become an important goal of technology innovation for information appliances.

With notebook computers, in addition to constant miniaturization of the elements, integrating the elements functions is also critical. Whenever the functions of more than one element are integrated into a single element, extra space may be saved to add elements with new functions. This also directly helps to achieve the goal of slim and light for notebook computers.

Notebook computers generally include a display panel and a processor that are formed in plates for folding over one another. In the developmental history of the notebook computer, there are two essential apparatus that have been enhanced merely in terms of individual functions but without functional integration. One is the coupling switch of the display panel and the processor, and the other is the power supply switch of the processor. The power supply switch of the conventional notebook computer is directly located on the processor. The coupling switch of the display panel is located on the display panel, and matches a coupling trough on the processor to allow a mechanical latching or unfastening operation to be performed. These two apparatus occupy separated space, which is against the space allocation requirement of the notebook computer that has been constantly reduced in size. Moreover, whenever the display panel is lifted and opened the notebook computer is to be used. However, the present structure requires users to unfasten the coupling switch of the display panel first, and then activate the power supply switch on the processor. The operation process is overly complicated.

### SUMMARY OF THE INVENTION

In view of the aforesaid disadvantages, the primary object of the invention is to provide a compound power supply switch for notebook computers to simplify opening operation of the notebook computers and reduce time of machine start operation.

Another object of the invention is to integrate the lift switch of the display panel and the power supply switch of the processor to save space and accommodate devices for other functions.

In order to achieve the foregoing objects, the compound power supply switch for notebook computers according to the invention mainly includes a coupling module and a power supply control module. The coupling module consists of a latch element on the display panel and an elastic element to keep the latch element at a latch position. The latch element has a hook section and an exposed actuating section. The hook section may latch onto a coupling trough formed on the processor when the latch element is located at the latch position. When the latch element is moved to an unfastening position, the hook section is separated from the coupling trough. The power supply module has a power supply actuation element and a power supply control circuit that are coupled together. The power supply actuation element abuts the coupling module. When the latch element is at the unfastening position, the power supply actuation element is triggered by the latch element to generate an activating signal, which is transferred to the power supply control circuit to activate the power supply of the processor. Hence, by integrating the lift switch of the display panel and the power supply switch of the processor of the notebook computer, users can lift and open the display panel and at the same time complete machine start operations of the notebook computer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the compound power supply switch of the invention for notebook computers.

FIG. 2 is a system block diagram of the first embodiment of the invention.

FIG. 3 is a perspective view of a second embodiment of the compound power supply switch of the invention for notebook computers.

### DESCRIPTION OF THE PREFERRED EMBODIMENTS

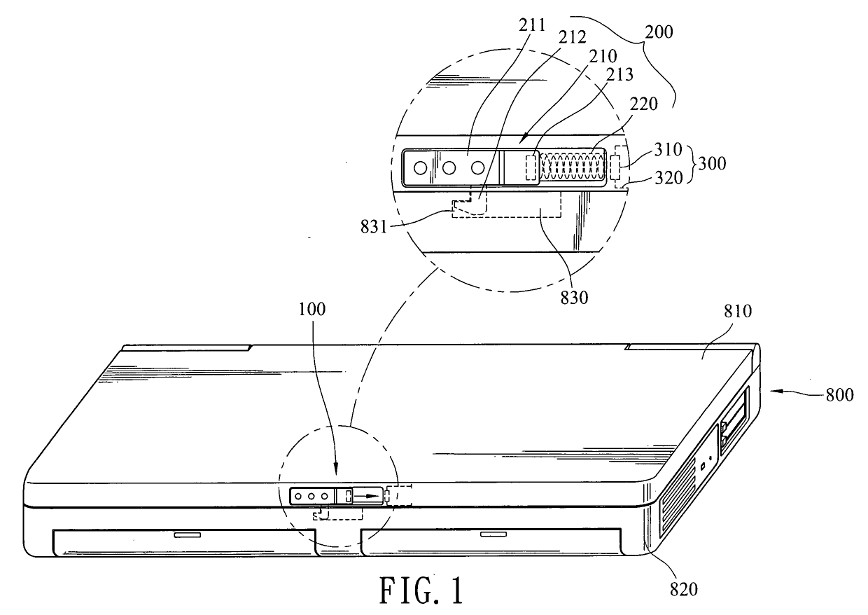

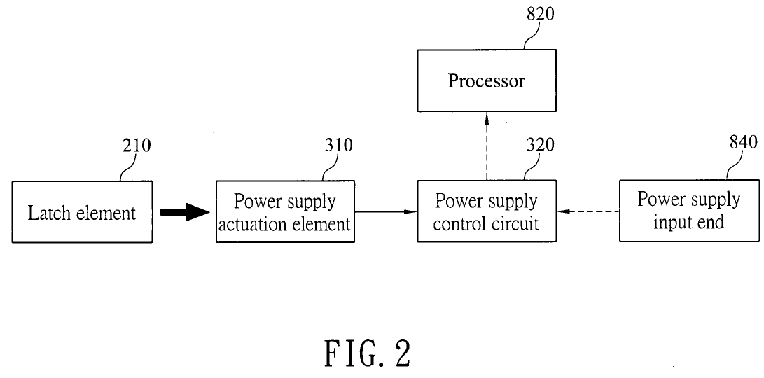

Refer to FIGS. 1 and 2 for a first embodiment of the compound power supply switch 100 for notebook computers according to the invention. It includes a coupling module 200 located on a display panel 810 of a notebook computer 800 and a switch control module 300 located on a processor 820 of the notebook computer 800 to actuate machine start operation.

The display panel 810 and the processor 820 are two plate-type objects folding over one another in an up and down manner, and are pivotally engaged with each other on a back end. The display panel may be lifted and opened at the front end. In practice, the display panel 810 may be a liquid crystal display (LCD), plasma display, electroluminescent display, light emitting diode (LED), vacuum fluorescent display, field emission display, electro-chromic display, organic electroluminescent display, and the like. The processor 820 has a coupling trough 830 on the front end of the top side.

The coupling trough 830 is extended leftwards to form a compartment 831. The coupling module 200 includes a latch element 210 and an elastic element 220 for keeping the latch element 210 at a latch position (at the left side shown in FIG. 1). The elastic element 220 may be a compression spring or other substitutes (such as a tension spring, with only a slight adjustment in location). The latch element 210 has an actuating section 211 exposed to the front side of the display panel 810. The actuating section 211 has a back side running through a side wall of the display panel 810 to extend downwards and form a hook section 212 directly to the left side. The actuating section 211 also has a bucking section 213 in contact with the elastic element 220. When the hook section 212 of the latch element 210 is pressed leftwards by the elastic element 220 and wedged in the compartment 831 of the coupling trough 830 of the processor 820, the latch element 120 is located at the “latch position.” When the latch element 120 is moved to the right, the hook section 212 escapes from the compartment 831 of the coupling trough 830 and becomes unfastened, then the latch element 210 is located at the “unfastening position.”

The power control module 300 includes a power supply actuation element 310 and a power supply control circuit 320. The power supply actuation element 310 is located on the right side of the coupling module 200. It is triggered to generate an activating signal only when the latch element 210 is moved to the unfastening position. Then through the power supply control circuit 320, the power supply of the processor 820 is activated. The power supply control circuit 320 connects the display panel 810 to a power supply input end 840 located on the processor 820. The circuit layout is known in the art, so details are omitted. In addition, in practice the power supply actuation element 310 may be one of various types of pushbuttons commonly used on electric appliances, or other structures that provide electromagnetic or current pulse signals through a brief contact.

Of course, every element of the coupling module 200 may be switched left and right as long as it corresponds to the compartment 831 of the coupling trough 830 of the power supply control module 300.

In the structure of the first embodiment set forth above, the latch element 210 is moved horizontally between the latch position and the unfastening position (or more precisely, moved reciprocally on a flat surface in parallel with the display panel 810). It not only can control the coupling and unfastening between the display panel 810 and the processor 820, the latch element 210 can also trigger the actuation element 310 at the unfastening position. Hence, through the actions of pushing the latch element 210 and lifting the display panel 810, the start operation of the processor 820 is also simultaneously activated. Therefore machine start operation of the notebook computer 800 is simplified, the time required for machine start operation is shortened, and operation convenience improves.

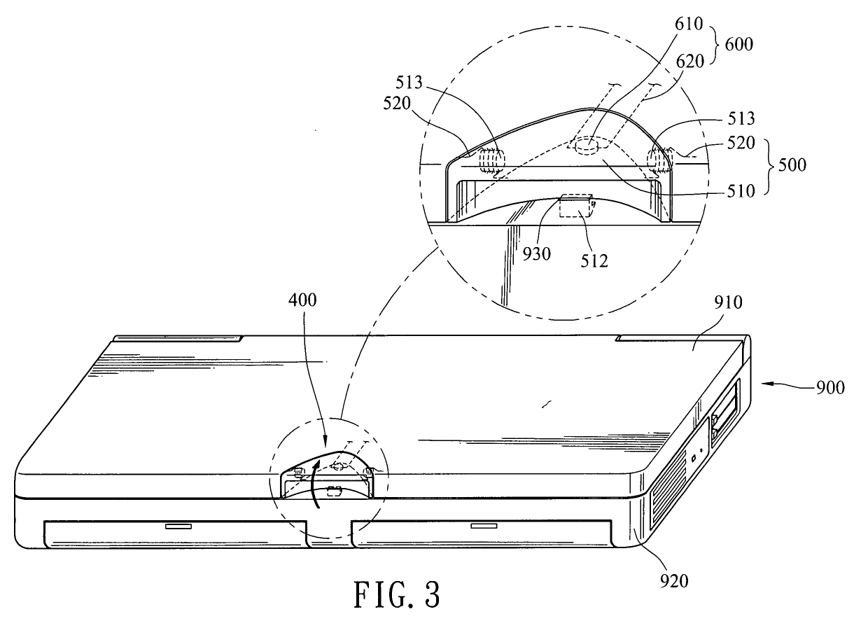

Refer to FIG. 3 for a second embodiment of the compound power supply switch 400 for notebook computers according to the invention. The main difference from the first embodiment is:

The coupling module 500 is a lifting type. It has a latch element 510 whose moving track is substantially normal to the flat surface of the display panel 910 of the notebook computer 900. As shown in the drawing, the latch element 510 of the coupling module 500 is formed substantially in the shape of a cake. It has axle struts 513 located on the left and right side to couple with an elastic element 520 (torsional spring) to keep the latch element 510 at a latched position. Of course, the elastic element may also be a compression or tension spring. The latch element 510 has an actuating section 511 that is located at the front end. It also has a hook section 512 located at the bottom side abutting the front end. The power supply actuation element 610 is located at a bottom side abutting the tail end. When users move the latch element 510 upwards, it turns about the axle struts 513 to an unfastening position. The hook section 512 escapes the coupling trough 930 of the processor 920 and is moved away from the latch position, and the tail end of the latch element 510 is moved downwards to compress the switch actuation element 610. Similarly, through the power supply control circuit 620, the processor 920 is started. Thus by lifting the display panel 910, machine start operation is activated at the same time. In practice, the location of the power supply actuation element 610 is not limited to the tail end of the latch element 510; it may be located at any position desired as long as it can be touched by the moving track of the latch element 510.

It is to be noted that the coupling module and the power supply control module may also be located on the processor, and the coupling trough corresponding to the latch element may be located on the display panel.

In summary, the techniques disclosed in the invention provide the following advantages:
1. Simplify open and machine start operations of notebook computers, and shorten the time required for machine start operation.
2. The space originally occupied by the power supply switch may be reallocated for other designs or uses such as radiation apertures, speaker or fingerprint scanner and the like, thereby providing additional functions and design space.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A compound power supply switch for notebook computers with an opening movement to activate a processor of a notebook computer and at the same time to disengage a display panel in an unfastening condition from the processor, the compound power supply switch comprising:
a coupling module located on the display panel having a latch element and at least one elastic element to keep the latch element at a latch position, the latch element being engaged with a coupling trough located on the processor at the latch position and being separated from the coupling trough at a unfastening position; and
a power supply control module having a power supply actuation element and a power supply control circuit, the power supply actuation element abutting the unfastening position and being triggered by the latch element when the latch element is located at the unfastening position to generate an actuating signal to activate the power supply of the processor through the power supply control circuit.

2. The compound power supply switch for notebook computers of claim 1, wherein the latch element has a hook section and an exposed actuating section, the hook section being coupled with the coupling trough at the latch position.

3. The compound power supply switch for notebook computers of claim 2, wherein the coupling trough extends in the direction of the latch position to form a compartment to latch the hook section of the latch element.

4. The compound power supply switch for notebook computers of claim 1, wherein the power supply actuation element is a pushbutton power supply switch to generate an electromagnetic or current pulse signal through a brief contact with the latch element.

5. The compound power supply switch for notebook computers of claim 1, wherein the power supply control circuit connects to a power supply input end located on the processor through the display panel.

6. The compound power supply switch for notebook computers of claim 1, wherein the latch element has a moving track substantially in parallel with the flat surface of the display panel.

7. The compound power supply switch for notebook computers of claim 6, wherein the latch element has a rectangular actuating section exposed outside the display panel and extended in the direction of the coupling trough to form a hook section, and a bucking section in contact with the elastic element.

8. The compound power supply switch for notebook computers of claim 1, wherein the latch element has a moving track substantially normal to the flat surface of the display panel.

9. The compound power supply switch for notebook computers of claim 8, wherein the latch element is formed substantially in the shape of a cake and has a hook section corresponding to the coupling trough, and an axle strut located respectively on two sides thereof to couple with the elastic element to push and turn the latch element about the axle strut to the unfastening position.

10. The compound power supply switch for notebook computers of claim 1, wherein the coupling module and the power supply control module are located on the processor, the coupling trough corresponding to the latch element being located on the display panel.

11. A compound power supply switch for notebook computers with an opening movement to activate a processor of a notebook computer and at the same time to disengage a display panel in an unfastening condition from the processor, the compound power supply switch comprising:
a coupling module located on the display panel having a latch element and at least one elastic element to keep the latch element at a latch position, the latch element being engaged with a coupling trough located on the processor at the latch position and being separated from the coupling trough at a unfastening position, the connecting track between the latch position and the unfastening position being substantially in parallel with the flat surface of the display panel; and
a power supply control module having a power supply actuation element and a power supply control circuit, the power supply actuation element abutting the unfastening position and being triggered by the latch element when the latch element is located at the unfastening position to generate an actuating signal to activate the power supply of the processor through the power supply control circuit.

12. The compound power supply switch for notebook computers of claim 11, wherein the latch element has a rectangular actuating section exposed outside the display panel and extended in the direction of the coupling trough to form a hook section, and a bucking section in contact with the elastic element.

13. The compound power supply switch for notebook computers of claim 12, wherein the coupling trough extends in the direction of the latch position to form a compartment to latch the hook section of the latch element.

14. The compound power supply switch for notebook computers of claim 11, wherein the power supply actuation element is a pushbutton power supply switch to generate an electromagnetic or current pulse signal through a brief contact with the latch element.

15. The compound power supply switch for notebook computers of claim 11, wherein the coupling module and the power supply control module are located on the processor, the coupling trough corresponding to the latch element being located on the display panel.

16. A compound power supply switch for notebook computers with an opening movement to activate a processor of a notebook computer and at the, same time to disengage a display panel in an unfastening condition from the processor, the compound power supply switch comprising:
a coupling module located on the display panel having a latch element and at least one elastic element to keep the latch element at a latch position, the latch element being engaged with a coupling trough located on the processor at the latch position and being separated from the coupling trough at a unfastening position, the connecting track between the latch position and the unfastening position being substantially normal to the flat surface of the display panel; and
a power supply control module having a power supply actuation element and a power supply control circuit, the power supply actuation element abutting the unfastening position and being triggered by the latch element when the latch element is located at the unfastening position to generate an actuating signal to activate the power supply of the processor through the power supply control circuit.

17. The compound power supply switch for notebook computers of claim 16, wherein the latch element is formed substantially in the shape of a cake and has a hook section corresponding to the coupling trough, and an axle strut located respectively on two sides thereof to couple with the elastic element to push and turn the latch element about the axle strut to the unfastening position.

18. The compound power supply switch for notebook computers of claim 17, wherein the coupling trough extends in the direction of the latch position to form a compartment to latch the hook section of the latch element.

19. The compound power supply switch for notebook computers of claim 17, wherein the power supply actuation element is a pushbutton power supply switch to generate an electromagnetic or current pulse signal through a brief contact with the latch element.

20. The compound power supply switch for notebook computers of claim 16, wherein the coupling module and the power supply control module are located on the processor, the coupling trough corresponding to the latch element being located on the display panel.
